(19) United States
(12) Patent Application Publication
(10) Pub. No.: US 2015/0285593 A1
(43) Pub. Date: Oct. 8, 2015

(54) MONITORING SHOTS OF FIREARMS

(71) Applicant: Ehud DRIBBEN, Shaarei Tikva (IL)

(72) Inventor: Ehud DRIBBEN, Shaarei Tikva (IL)

(21) Appl. No.: 14/687,960

(22) Filed: Apr. 16, 2015

Related U.S. Application Data
(63) Continuation-in-part of application No. 13/498,326, filed on Mar. 26, 2012, now Pat. No. 9,022,785.

(30) Foreign Application Priority Data
Jan. 26, 2010 (IL) 203526

(51) Int. Cl. F41G 3/26; G01L 5/00; F41A 35/00; G01P 15/00

(52) U.S. Cl. CPC F41G 3/26; G01P 15/00; G01L 5/0052; F41A 35/00

(57) ABSTRACT

A device and system for monitoring shots fired by a specific user, the system comprising a processor and a monitoring device for monitoring shots fired by a specific user, the device comprising an identification module to store an exclusive identification specific for the user and to ascribe the exclusive identification to the user, a memory module, a wireless communications module, and an accelerometer and a gyroscope to sense data about the amplitude and direction of movements of a user's hand and to provide the data to the processor, the processor external to the device, via the wireless communications module, wherein the processor is configured to receive data from the device and to process the data to identify typical movement patterns before, during and after a firing.

### CROSS REFERENCE TO RELATED APPLICATIONS

This application is a continuation-in-part of U.S. patent application Ser. No. 13/498,326, filed on Mar. 26, 2012, which is a National Phase Application of PCT International Application No. PCT/US2011/022327, International Filing Date Jan. 25, 2011, entitled: “MONITORING SHOTS OF FIREARMS”, published on Aug. 4, 2011 as International Publication No. WO 2011/094177, claiming the benefit of Israeli Patent Application No. 203526, filed on Jan. 26, 2010, all of which are incorporated herein by reference in their entirety.

### BACKGROUND OF THE INVENTION

1. Technical Field

The present invention relates to the field of firearms accessories and more particularly, to firearms accessories for firing management, monitoring, analysis and feedback while training in live fire.

2. Discussion of Related Art

Firearms are utilized for a variety of purposes, such as hunting, sports competition, and law enforcement. To teach accuracy and correct technique in shooting a firearm, target practice areas may be utilized wherein, for example, multiple shooters shoot live ammunition at multiple targets under the supervision of an instructor. To keep track of the accuracy or shooting technique of one or more shooters, it is often necessary for an instructor or a shooter to be able to review observe specific shooting skills in real time.

Known methods for identification of shooting may recognize shooting by measuring the pressure applied on the weapon's handle. Such method may be suitable for certain kinds of weapons, such as a pistol, in which the intensity of the pressure on the handle predicts the firing quality. However, in many kinds of weapons, such as rifles, the intensity of pressure on the handle cannot predict the firing quality. Additionally, in such methods, the quality of the shooting may be assessed by the manner of holding and pressure applied on the weapon. However, this method of assessment provides poor prediction of the quality and/or success of the shooting, for example, of the ability to hit the target. Additionally, such method is not very reliable for detection and identification of the deferent types of shooter's movements before, during and after the firing.

Additionally, known shooting management systems enable assessment of a single shooter in comparison to predetermined parameters of pressure intensity, on the handle and on the trigger. These methods are not suitable for simultaneous management of the entire shooting arena. Additionally, these methods may require several devices to be installed on the weapons, which may limit and alter significantly the natural movements of a shooter. In systems intended for simulation of real firing conditions, these parameters may be critical.

For example, known methods use a communication and/or power cable to connect the weapon to a computer, thus limiting the natural movement of the shooter. In order to sense the pressure on the trigger and the handle, these methods must provide power to the handle and trigger continuously. Additionally, in known methods a laser pointer or another suitable marking means may be installed on the weapon in order to mark a hit on the target for detection by a camera. All these devices on the weapon may make these known methods very inconvenient and limiting and decrease the usability of these known methods for realistic simulations.

### SUMMARY OF THE INVENTION

Some embodiments of the present invention provide a device and system for monitoring shots fired by a specific user, and the system may include a processor and a monitoring device for monitoring shots fired by a specific user.

The monitoring device for monitoring shots fired by a specific user, according to embodiments of the present invention, may include an identification module to store an exclusive identification and to enable exclusive identification of a specific shooter by ascribing the exclusive identification to the shooter, a memory module, a wireless communications module, and a motion sensor to sense data about the amplitude and direction of movements of a user's hand and to provide the data to the processor.

According to some embodiments of the present invention, the processor may be external to the device and/or the accelerometer and gyroscope may provide data to the processor via the wireless communications module. The processor may be configured to receive data from the device and to process the data to identify typical movement patterns before, during and after a firing.

According to some embodiments of the present invention, the processor may be configured to isolate at least horizontal movement of the hand and depth movement of the hand.

According to some embodiments of the present invention, the processor may be configured to identify recoil movement and deduce that a shot has been fired at the same time that the recoil movement occurred.

According to some embodiments of the present invention, the device may further include attachment straps to facilitate attachment of the device to a wrist of a user.

According to some embodiments of the present invention, the device may further include a processing module to at least partially process data before providing the processed data to the external processor.

According to some embodiments of the present invention, the device may further include at least one physiological sensor to sense data about physiological measures that imply on physiological or emotional conditions of the user and to provide the data to the external processor via the wireless communications module.

According to some embodiments of the present invention, the device may further include an audio sensor to detect audio data comprising sounds made by the user, by the weapon and/or from the user's environment and to provide the data to the external processor via the wireless communications module.

According to some embodiments of the present invention, the memory module may store at least one of a list comprising: shooting history, performance, rank, and/or any other suitable data about the specific user.

According to some embodiments of the present invention, the identification module may include RFID reader for synchronization with a corresponding RFID tag on a corresponding weapon or target.

According to some embodiments of the present invention, the processor may be calibrated to identify different types of movement according to various parameters.

According to some embodiments of the present invention, the system my further include an impact recorder to detect impacts of shots on a target, wherein the processor is further configured to attribute data received from the impact recorder to the correct user exclusively.

According to some embodiments of the present invention, the system may include a plurality of monitoring devices, each identified exclusively with a respective shooter by the identification module of each device, and the system may further include a timer and a plurality of impact recorders on respective targets, wherein the processor may be configured to receive data from the plurality of monitoring devices and impact recorders in parallel, to process the data to identify typical movement patterns before, during and after firing and to time identified shots, made by the respective identified shooters, and.

### BRIEF DESCRIPTION OF THE DRAWINGS

The present invention will be more readily understood from the detailed description of embodiments thereof made in conjunction with the accompanying drawings of which:

FIG. 1 shows a shooting range management system, according to some embodiments of the invention;

FIG. 2 is a schematic illustration the components of some of the shooting range management system shown in FIG. 1, according to some embodiments of the invention;

FIG. 3 shows details of a graph related to the shooting range management system shown in FIG. 1, according to some embodiments of the invention;

FIG. 4 is a schematic illustration of a device for monitoring shots fired by a user according to embodiments of the present invention.

FIG. 5 is an exemplary schematic graph illustration of technical data displayed on a display of computer, provided by a shooting range management system according to embodiments of the present invention.

FIG. 6 shows a schematic illustration of a large group embodiment of the shooting range management system shown in FIG. 1, according to some embodiments of the invention; and

FIG. 7A shows yet another aspect of a shooting range management system, according to some embodiments of the invention;

FIG. 7B shows details of a graph related to the shooting range management system shown in FIG. 7A; and

FIG. 7C shows details of yet another graph related to the shooting range management system shown in FIG. 7A.

### DETAILED DESCRIPTION OF THE INVENTION

Prior to setting forth the detailed description, it may be helpful to set forth definitions of certain terms that will be used hereinafter.

As used herein, the term “shooting range” encompasses firing ranges, target ranges, shooting training, smart shooting range or other weapons training or testing environments or configurations.

As used herein, the phrases “multiple user shooting ranges”, “multiple user shooting areas”, or similar phrases refer to areas in which there are multiple shooters users shooting in areas in which there is firing range management.

As used herein, the phrase “firing range management” refers to, inter alia, group shooting; multi-user shooting; time-challenged shooting; smart shooting ranges; timed shooting management, and other group oriented shooting or training implementations.

As used herein, the terms “ballistic weapon” or “weapon” refer to any armament that shoots projectiles after power has been cut off and includes, inter alia, any ballistic weapon that is held by one or two hands, or shoulder or torso mounted, or held away from the body.

As used herein, wireless data input technologies to communicate signals or data, comprise communication technologies using LAN, WLAN, Bluetooth, Zigbee, Ethernet, USB, cables, and any other wireless technology presently existing or developed in the future.

Before at least one embodiment of the invention is explained in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

Some embodiments of the present invention provide a shooting range management system. The shooting range system, according to some embodiments of the present invention, may analyze amplitude and direction of the shooter's wrist movement, and identify by the analysis different movement types which may imply on the quality of performance of the shooter. By the analysis, recoil movement caused by the firing and other characteristics of the shooter's performance may be identified.

In contrast to known methods, the system according to the present invention may enable realistic simulation of a combat. According to embodiments of the present invention, preferably no equipment is installed on the weapon itself. Additionally, no cables are attached to the shooter and/or to the weapon, enabling free movement of the shooter.

In contrast to known methods, the system according to some embodiments of the present invention may enable management and analysis of a group realistic training, by monitoring multiple aspects of the group training such as, for example, overall number of shots, overall target impact success percentage (of the number of shots), number of impacts on the target, the time of each shot and/or of each hit on the target, final time of the entire shooting session and/or shots per second or another period of time, and comparisons between the group members in number of shots and/or success percentage and/or in any other suitable comparison parameter. The system according to some embodiments of the present invention is designated to provide group data by receiving, assembling and/or analyzing data from multiple shot recorders, each associated exclusively with an identified user, and from multiple impact recorders, wherein each impact recorder is associated exclusively with an identified user. Additionally, the system according to some embodiments of the present invention may enable real time management, analysis and monitoring of several distinct groups and make real time comparisons between the groups, in all the above mentioned parameters. In contrast to known methods, in some embodiments of the present invention, impact may be detected by impact recorders on the target, sensing directly the actual impacts on the targets without any laser equipment on the weapons.

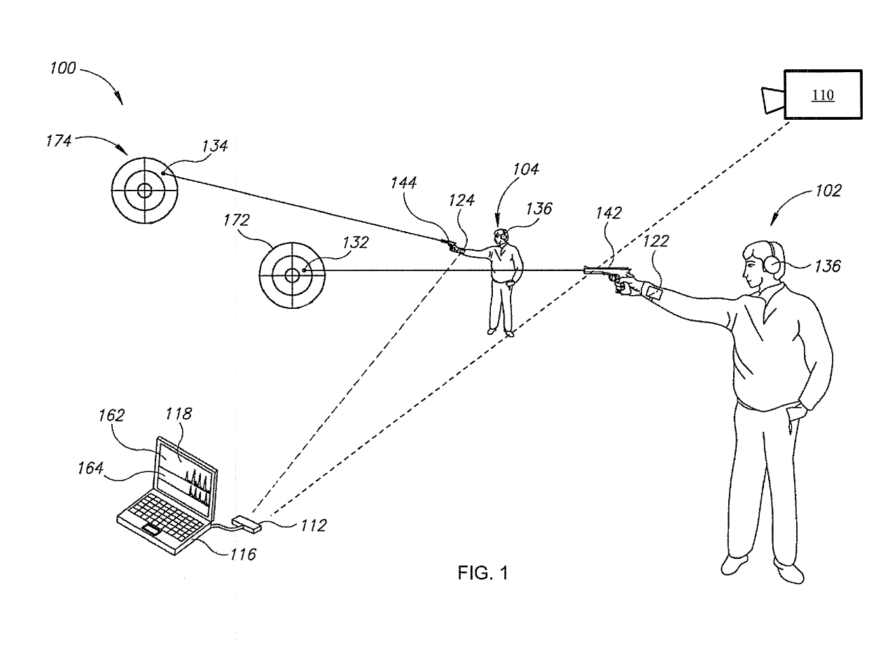

Reference is now made to FIG. 1 which illustrates a shooting range management system 100. Shooting range management system 100 may include an impact recorder 110, at least one shot recorder 122 and/or 124, a receiver 112 and a computer/processor 116. A first shooter 102, wearing a shot recorder 122, is aiming a weapon 142 at a target 172. A second shooter 104, wearing a shot recorder 124 is aiming a weapon 144 at a target 174.

Shot recorders 122 and 124 are typically worn on the wrist or arm of shooters 102 and 104 respectively and record: (i) wrist movement; (ii) cocking of the trigger, rotating the barrel, or pulling the slide bar of weapon 142 or 144; or (iii) the exit blast as bullets 132 and 134 leave weapons 142 and 144 respectively. In some embodiments of the present invention shot recorders 122 and/or 124 can be installed on the weapon 142 and/or 144.

Shot recorders 122 and 124 contain one or more sensors, such as an accelerometer, a gyroscope, physiological sensors and/or any other suitable sensors such as, for example, vibration sensor, shock sensor, motion sensor, sound sensors, pressure sensors and trigger movement sensors, or any other suitable sensor for identifying movement and blasts associated with weapons 142 and 144. Shot recorders 122 and 124 are depicted in more detail in FIG. 4, showing a user shot monitoring device 600 which may be an embodiment of shot recorders 122 and 124 in some embodiments of the present invention.

Shot recorders 122 and 124 transmit data with respect to movement and exit blasts associated with weapons 142 and 144 to a computer/processor 116 via a receiver 112.

Computer/processor 116 may be included in any suitable device such as, for example, a computer, a laptop computer, a mobile phone and/or any other suitable device having computing and/or processing abilities. Preferably, computer/processor 116 and/or the device including computer/processor 116 may include and/or be connected to a display 118.

Impact recorders 110 may record the impact of shots 132 and 134 that hit target 172 and 174 respectively, and transmits the recorded data to receiver 112. Impact recorders 110 include any type of sensor, including inter alia, vibration sensors, shock sensors, motion sensors, sound sensors, an imaging device and pressure sensors; or any other suitable sensor for identifying and/or measuring a shot hitting a target. Data is transmitted wirelessly as shown.

In some embodiments of the present invention, impact recorder 110 may be or include a camera directed to a target 172 and/or target 174. Impact recorder 110 may include any kind of camera, including still camera and/or video camera and/or a three-dimensional camera and/or sensor. Computer/processor 116 may receive image data from impact recorder 110, identify in the images hits on target 172 and/or target 174, time the hits and ascribe a hit to a recorded shot and a specific user who made the shot. Computer/processor 116 may receive image data from multiple impact recorders 110, for example each directed to a specific target or, in other embodiments, a camera may be directed to and/or monitor specific several targets, and, for example, be recorded as ascribed to the specific target or the specific several targets. Computer/processor 116 may distinguish between the cameras and/or the target(s) included in the image data and thus, for example, distinguish between the hits, and/or ascribe hits to shots, for example, according to the times of shots and hits. The shots may be performed by the same user or by several users. Computer/processor 116 may identify shots and ascribe the shots to respective shooters, time the identified shots and match identified hits to identified shots monitored by the camera(s). Thus, for example, computer/processor 116 may provide an accurate report on the shots, hits and times and, for example, to provide an accurate analysis of the shooter(s) performance, relevant to the results and the shooter's movements.

In some embodiments, impact recorders 110 may include a three-dimensional camera and/or sensor which may sense the impacts and/or the shooter's movements, such as to provide analysis of the shooting by three-dimensional movement sensing.

Receiver 112 then integrates the data from shot recorders 122 and 124, and impact recorders 110, and produces time-based information on shots 132 and 134 that is displayed on a display 118 connected to computer/processor 116.

A third shooter 160 without shot recorder 122 on his wrist has begun shooting at a target 170 and, could possibly skew the data from shot recorders 122 and 124, impact recorders 110, and/or receiver 112. As explained below, shooting range management system 100 optionally includes a filter system to filter out unwanted noise (again noise filter).

As shown, shooting range management system 100 optionally includes earphones 136 (it can also be an outside beep and not in earphones) so that each shooter 102 and 104 hears instructions, such as “begin shooting” and “cease fire” from an instructor (not shown).

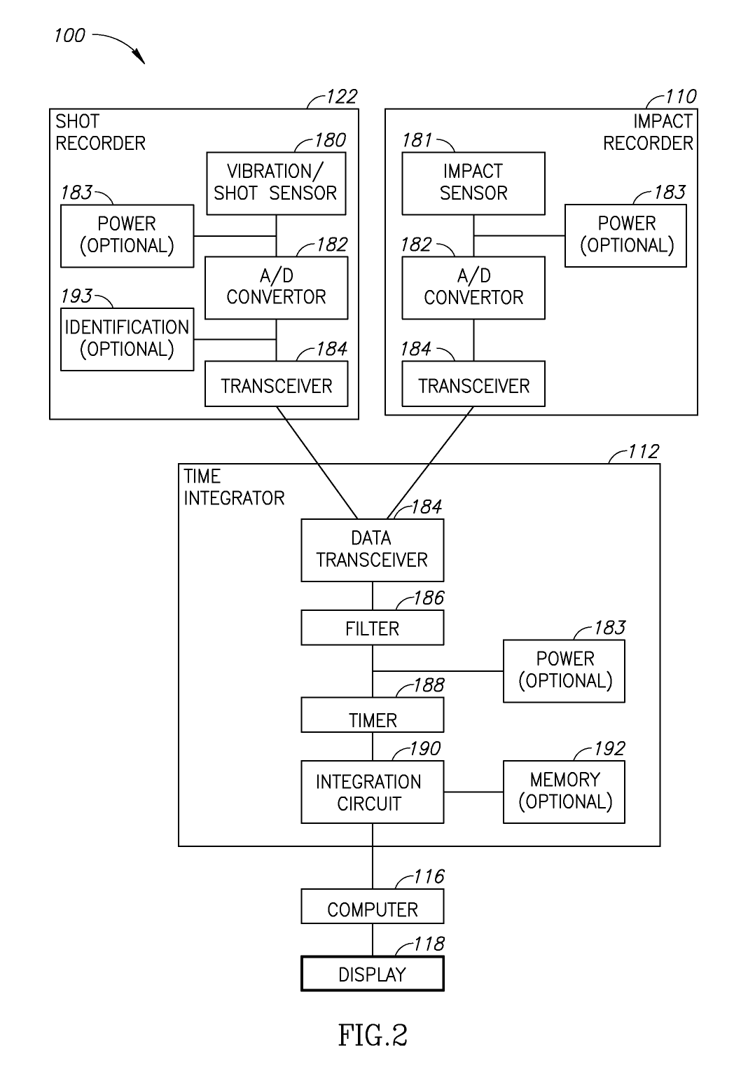

FIG. 2 shows a schematic diagram of components of shooting range management system 100, in which shot recorder 122 includes a vibration sensor 180 which transfers the sensed data to an analog-to-digital (A/D) converter 182. A/D converter 182 converts the vibration signals into digitally transmittable signals. Shot recorder 122 additionally includes a transceiver 184 which then transfers the digital data to receiver 112.

In some embodiments, shot recorder 122 may optionally include an identification module 193 that identifies shot recorder 122 exclusively. Identification module 193 records, for example, the shooting history, being a temporal sequence of shots and hits of a particular weapon, and optionally provides a warning, for example when the weapon requires maintenance cleaning, or part replacement.

When used by a specific shooter, identification module 193 optionally receives data from receiver 112 and may be taken home by the shooter registered with identification module 193, for example, to download information on a home computer and compare a current session with previous sessions. Deactivation and Activation of shot recorder 122 to function with the correct weapon is optionally provided by an RFID tag on the weapon and an RFID reader in identification module 193. The data may be transferred directly to a communication device.

Transceiver 184 in addition to transmitting data to receiver 112, may also serve as a receiver of information via receiver 112 which is optionally initiated for example by computer/processor 116. Such received information may be a command that is typed into computer/processor 116 to shut down shooting range management system 100.

Receiver 112 includes data transceiver 184 which receives data from both shot recorder 122 and impact recorders 110. In some embodiments, receiver 112 and/or some components of receiver 112 may be embedded within shot monitoring device 600 (shown in FIG. 4), for example, together with shot recorder 122.

In embodiments, receiver 112 includes a filter 186 that filters out unwanted noise from shots such as a shot from shooter 160 (FIG. 1) that may, for example, be interpreted as hand movement by shooters 102 and 104.

After passing through filter 186, the data is passed to a timer module 188 which assigns time variables to each dataset passed on from shot recorder 122 and impact recorders 110.

Receiver 112 includes a timer module 188, for example including a digital clock, which may be set at real time, for example 3:40 PM and 20 seconds. Alternatively or additionally, timer module 188 includes a digital clock that is set at zero at the beginning of a shooting session or shooting period, by the instructor. The digital clock included in timer module 188 optionally provides timing increments at thousandth or ten thousandth of a second in order to provide precise records of shooters 102 and 104. Such increments of each second have application in situations wherein rapid fire, for example from multiple users armed with semi-automatic or automatic weapons, is being monitored.

The data is then passed on to an integration circuit 190 which then correlates the various blasts with their corresponding captured impact and transfers the information to computer/processor 116.

Computer/processor 116 provides the information in the above-noted visual display 118 as well as an optional audio transmittal. Receiver 112 optionally includes a memory 192 which allows the information collected from shot recorder 122 and impact recorders or from image 110 to be stored and possibly downloaded to another computer for future reference and or comparison to other sessions utilizing a second computer (can also be watch, PDA, cell phone).

Shot recorder 122, impact recorders 110, and/or receiver 112, optionally include power supplies 183. As noted above, in alternative embodiments, power may be supplied through wiring passing from computer/processor 116 to all components and/or direct wiring of the various components to a separate electric connection. The many ways of providing power to the components shown are well known to those who are familiar with the art. Power supplies 183 may include, for example batteries, for example, chargeable batteries.

Receiver 112, shot recorders 122 and 124 and other components of shooting range management system 100, for example the safety module explained below, optionally operate using rechargeable batteries or rechargeable power units. Alternatively, power is provided by a local generator or wiring to a power supply.

In some embodiments of the invention, receiver 112, shot recorders 122 and 124 and other components of shooting range management system 100, are optionally contained in shock-resistant housings to prevent environmental vibrations from affecting collected data. Such environmental vibrations might include, for example, vibrations generated by overflying aircraft, or vehicles passing near shooting range management system 100.

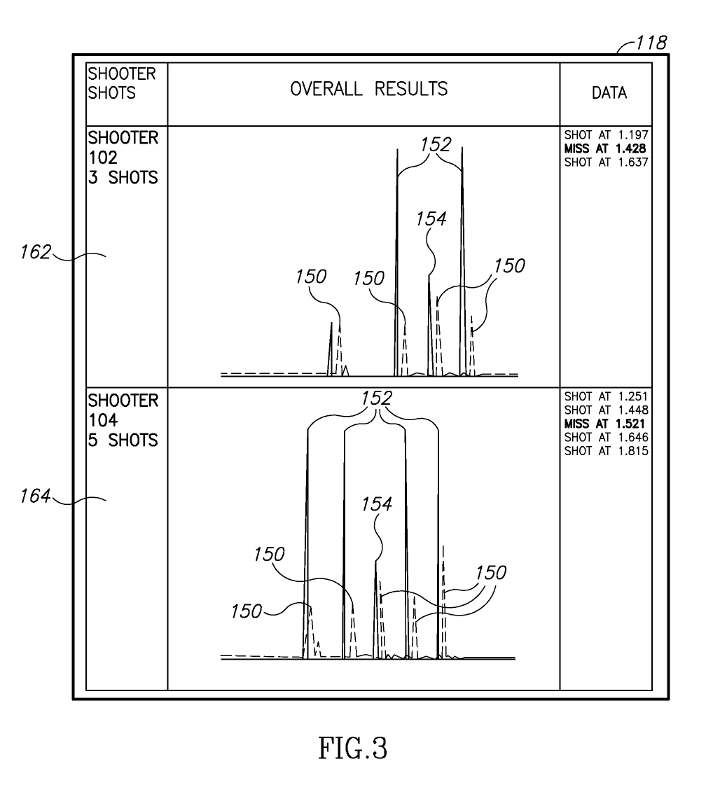

FIG. 3 is a schematic illustration of details of technical data displayed on display 118 of computer/processor 116, provided by shooting range management system 100 according to embodiments of the present invention. Shooting range management system 100 may provide a wide variety of technical data that may be displayed on display 118.

Display shows data tables 162 and 164, which illustrate, in the left column, that shooter 102 shot three shots and shooter 104 shot five shots.

The middle graph section of data tables 162 and 164 shows that shooter 102 made a hand movement 150 without firing one time, executed a hit 152 of the target two times, and registered a shot failure 154 one time.

Additionally, shooter 104 hit 152 the target four times and failed 154 one time.

In addition to determining the ability of shooters 102 and 104 to hit the target, by analyzing movement 150, an instructor can optionally determine the movement of the hands and/or weapons of shooters 102 and 104, thereby providing pointers for improving the handling of the respective weapons and enabling an instructor to suggest suitable instructions for improving and/or correcting the shooter's firing technique.

For example, in misses 154 by both shooters 102 and 104, movement 150 indicates excessive time in cocking the weapons and/or excessive hand movement in aiming the weapons. Movement 150 in these cases can be indicative, for example, of hand movement which caused the weapon to lose alignment with the target.

Data column on the right shows the timing of each shot. Alternatively, the shooting instructor can optionally switch the data column to show, inter alia, the amount of time spent on each cock and/or aiming and/or drawing 150 during a given shot, and/or the times between shots and/or the complete shooting time, which can provide vital information in recommendations that improve the shooting technique of shooters 102 and 104.

While the utilization of shooting range management system 100 and the associated graphs 118 are illustrated with respect to two shooters 102 and 104, the present invention is contemplated for use with only one shooter 102. It is understood that some embodiments of the present invention may support two or more shooters shooting a common target or alternatively—each shooter is assigned with his or her target or targets respectively. In use with single shooter 102, as is optionally provided with multiple shooters, graphs 118 aid shooter 102 in determining a variety of technical data. Technical data provided by graph 118, includes, inter alia: intervals between each shot; hand and weapon movements prior to, during, and following shooting; and accuracy of hitting target 172.

Reference is now made to FIG. 4, which is a schematic illustration of a user shot monitoring device 600 for monitoring shots by a user, according to embodiments of the present invention. Monitoring device 600 may include, for example, a motion sensor which may include, for example, an accelerometer 612 and/or a gyroscope 614, identification module 616, memory module 622 and communications module 624. Additionally, shot recorder 600 may optionally include a processing module 623, which may be included in memory module 622. Additionally, monitoring device 600 may optionally include an audio sensor 618. Additionally, monitoring device 600 may optionally include one or more physiological sensors 620, which may include, for example, heartbeat sensor, blood pressure sensor, perspiration sensor and/or any other suitable physiological sensor(s). Additionally, monitoring device 600 may include attachment straps 610 which may facilitate attachment of monitoring device 600 to a wrist of a user, for example a potential shooter. Additionally, monitoring device 600 may optionally include an on/off button 626. In some embodiments, devices 600 may also include a GPS device to determine location of the shooter.

When monitoring device 600 is attached to a wrist of the hand used by the user for shooting, for example, during a shooting practice session, accelerometer 612 and gyroscope 614 may sense the amplitude and direction of movements of the user's hand. Additionally, physiological sensors 620 may sense physiological measures, which may imply, for example, on physiological and/or emotional conditions of the user. Additionally, audio sensor 618 may detect sounds made by the user, by the weapon and/or from the user's environment. In order to provide sensed data by accelerometer 612, gyroscope 614, and optionally physiological sensors 620 and/or audio sensor 618, monitoring device 600 may be required to be turned on by on/off button 626.

Once the shot is performed, the shooters hand may move, for example, in a pattern typical for shooting. Accelerometer 612 and gyroscope 614 may sense the amplitude and the direction of the movement, and provide the data to processing module 623 and/or to computer/processor 116, for example by communication module 624. Physiological sensors 620 and/or audio sensor 618 may also provide the sensed physiological measures and/or the sensed sounds data to processing module 623 and/or to computer/processor 116. It will be appreciated that, according to some embodiments of the present invention, at least some of the operations that may be performed by computer/processor 116 according to the present description may be performed, at least partially, by processing module 623. In such embodiments, data from accelerometer 612, gyroscope 614, physiological sensors 620 and/or audio sensor 618 may be provided to computer/processor 116, for example additionally or alternative to processing module 623. In some embodiments, at least some of the data processing may be performed by processing module 623 and then, partially processed data may be provided to computer/processor 116, for example by communications module 624, to complete the data processing.

Communications module 624 may transmit the data wirelessly in order to refrain from limiting and/or affecting the shooter's ability to move freely.

In some embodiments of the present invention, additional sensors may be included in monitoring device 600 and/or be in communication with monitoring device 600, such as pressure sensors, barometer, anemometer and/or movement sensors and/or any other suitable sensors, which may facilitate the identification of a shot and/or performance assessment of a shooter. Data from such additional sensors may also be provided to processing module 623 and/or to computer/processor 116.

Processing the data received from accelerometer 612 and gyroscope 614 may include, for example, analyzing the sensed movement amplitude data, direction data and/or physiological data and/or any additional sensed data and recognize movement patterns. Processing module 623 and/or computer/processor 116 may analyze the received data and distinguish, for example, hand movement in or opposite to the firing direction, i.e. towards or away from the target and/or the firing direction (also referred herein as depth movement) from hand movement perpendicular to the firing direction (also referred herein as horizontal movement). Additionally, processing module 623 and/or computer/processor 116 may analyze the received data and recognize different movement types and/or movement patterns. For example, processing module 623 and/or computer/processor 116 may recognize movement patterns with certain parameters such as, for example, amplitude of the movement, direction of the movement, frequency of the movement and/or any other suitable parameter, and based on the parameters identify the type of the movement, and/or isolate a certain type of movement from other movements. The types of movement that may be identified and/or isolated by processing module 623 and/or computer/processor 116 based on the analysis may include, for example, pulling out of the weapon, cocking of the weapon, rotating of the barrel, aiming, body tension before firing, recoil movement, pre-shooting movement (“flinch”), the movement patterns just before and/or just after the firing and/or any other relevant type(s) of movement. When recoil movement is identified and/or isolated, processing module 623 and/or computer/processor 116 may deduce that a shot has been fired at the same time that the recoil movement occurred. Optionally, in some exemplary embodiments, audio sensor 618 may facilitate the shot recognition.

Processing module 623 and/or computer/processor 116 may evaluate the performance level of the shooter, including, for example, the quality of a shot, based on analysis of the characteristics of the identified types of movements and/or physiological data, before, during and after an identified recoil movement (i.e., identified shot). By combination of the quality of the shot with the impacts detected by, for example, the camera, the present invention may provide accurate shooting analysis. In some embodiments, the data and/or analysis of the characteristics of the identified types of movements and/or physiological data may be presented on a screen and/or may be printable of provided in any other suitable manner to a user. Evaluation of the performance level may also be presented and/or provided to a user, and/or the user may evaluate the performance level based on the presented and/or provided analyses and/or data. Based on the characteristics of the of the identified types of movements, processing module 623 and/or computer/processor 116 may provide feedback regarding different aspects of the shooter's performance, such as, for example, correct and/or incorrect hand movements before, during and/or after the shot, the stress level of the shooter, the shooter's preparedness, the shooter's agility and/or any other suitable aspect.

The different types of movement may be identified by processing module 623 and/or computer/processor 116 according to calibration, for example predetermined calibration, of relevant parameters in processing module 623 and/or computer/processor 116, for example by a user and/or machine learning.

Identification module 616 may store an identification code, number, file, image or any other suitable identification. Identification module 616 may enable exclusive identification of a specific shooter by ascribing a specific identification, stored in identification module 616, to a specific shooter. In some embodiments, identification module 616 may be included in memory module 622. Memory module 622 may also store shooting history, performance, rank, and/or any other suitable data about the specific user. However, preferably, shooting history and specific user related data will be stored in computer/processor 116. In some embodiments of the present invention, data may be downloaded from memory module 622 to any suitable device and/or computer.

Identification module 616 may be used by processing module 623 and/or computer/processor 116 to identify the specific shooter and, for example, to attribute data received from impact recorder 110 to the correct weapon/user exclusively. For example, in some embodiments of the present invention, monitoring device 600 and impact recorder 110 and/or the weapon may be synchronized and/or coordinated by identification module 616, for example for correct relation of a specific user to a specific target and/or to a specific weapon. In some embodiments, identification module 616 may include RFID reader for synchronization and/or coordination, for example by corresponding RFID tags on corresponding weapons and/or targets.

As explained in detail herein, shooting range management system 100 according to embodiments of the present invention may include a plurality of monitoring devices 600, each worn, for example, on a wrist of a respective shooter and identified with the respective shooter, for example by identification module 616. Computer/processor 116 is configured, for example as explained in detail herein, to detect exit blasts of all shots fired by the respective identified shooters from a plurality of respective ballistic weapons, for example by recognizing and/or isolating recoil movement based on analysis of amplitude and/or direction of movement, as explained in detail herein. The recoil movement may imply that a shot has probably occurred. More specifically, the time of the recoil movement may be recorded by system 100 as the time of occurrence of the exit blast as a bullet leaves the weapon.

As described in detail herein, processing module 623 and/or computer/processor 116 may receive data from monitoring devices 600 and/or for example, from a plurality of impact recorders 110. Each of impact recorders 110 may be configured to detect impacts of shots, for example, on a respective target. As described in detail herein, computer/processor 116 may include or may communicate with a receiver 112, which may be configured to wirelessly receive detected exit blasts data and impacts data from monitoring devices 600 and/or from impact recorders 110. Receiver 112 may include a timer 188, by which computer/processor 116 may time shots of a plurality of users in parallel, for example shots identified by identifying recoil movements at the time of exit blasts from the plurality of weapons and to time impacts thereof and/or to produce data records thereof. Processing module 623 and/or computer/processor 116 may extract information from the received data, as described in detail herein.

Further as described herein, the system according to some embodiments of the present invention may include a display 118, which may be configured to display the received and/or analyzed data.

For example, processing module 623 and/or computer/processor 116 may recognize movement patterns with certain parameters such as, for example, amplitude of the movement, direction of the movement, frequency of the movement and/or any other suitable parameter, and based on the parameters identify the type of the movement, and/or isolate a certain type of movement from other movements. For example, based on the analysis, processing module 623 and/or computer/processor 116 may identify and/or isolate, for example, pulling out of the weapon (drawing), cocking of the trigger, rotating of the barrel, aiming, body tension before and/or after firing, recoil movement, the movement patterns just before and/or just after the firing and/or any other relevant type(s) of movement.

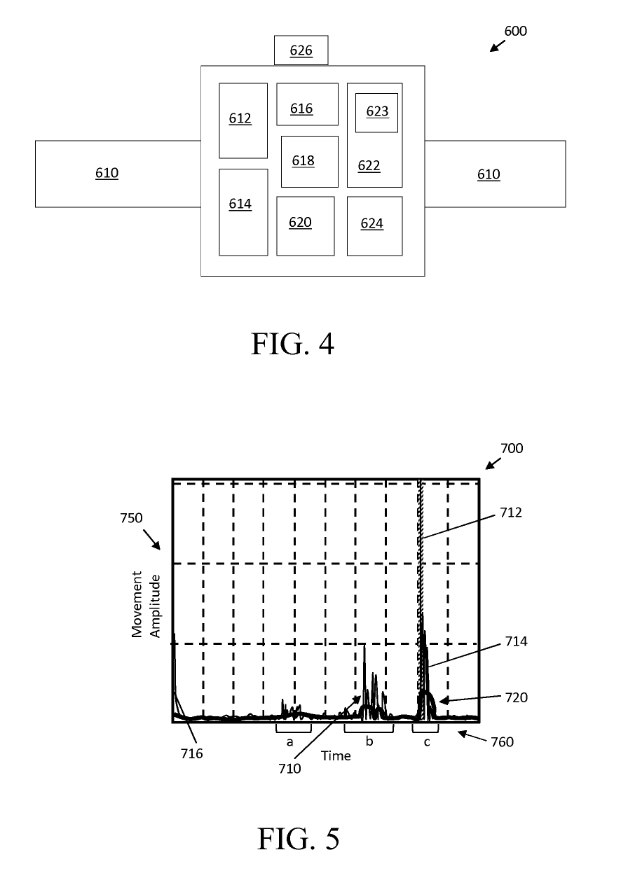

Reference is now made to FIG. 5, which is an exemplary schematic graph illustration 700 of technical data displayed on display 118 of computer/processor 116, provided by shooting range management system 100 according to some embodiments of the present invention. Graph illustration 700 includes a vertical axis 750 representing the amplitude of the wrist movement and a horizontal axis 760 representing time, for example starting from the moment the weapon is drawn. According to some embodiments of the present invention, processing module 623 and/or computer/processor 116 may isolate horizontal movement of the wrist, shown by the thick line 720, and depth movement of the wrist, shown by thin line 710. An exemplary initial drawing movement 716 is shown at the beginning of time axis 760. In some embodiments, processing module 623 and/or computer/processor 116 may isolate three axes of movements such as, for example, horizontal movement of the wrist, vertical movement of the wrist, and depth movement of the wrist (forward and backwards movements), and three corresponding lines may be shown in a graph illustration.

Firing may be identified by isolating movement identified by processing module 623 and/or computer/processor 116 as recoil movement, usually a very sharp depth movement. Graph 700 shows an exemplary identified shot recoil movement 712. When recoil movement is identified and/or isolated, processing module 623 and/or computer/processor 116 may deduce that a shot has been fired at the same time that the recoil movement occurred. As discussed in detail above, processing module 623 and/or computer/processor 116 may isolate and/or identify different types of movement before, during and after the firing.

Graph 700 shows exemplary identified and/or isolated movement types a, b and c, which may be identified by processing module 623 and/or computer/processor 116 as cocking of the trigger, rotating of the barrel, aiming, body tension before and/or after firing and/or other typical movement patterns. The identified movement types may be recorded by processing module 623 and/or computer/processor 116 together with their intensity (amplitude) the time of occurrence and/or other identified parameters and/or in relation to the specific shooter and or group the shooter belongs to. The recorded data may be stored, for example, in memory 192, in computer/processor 116, in memory 622 and/or in any other suitable data storage device.

As seen in FIG. 6, shooting range management system 100 may be utilized for many more than the illustrated multiple shooters 102 and 104; for example six, eight, ten, thirty, fifty or even more shooters.

In some embodiments of the inventions, shooting range management system 100 may include a safety module 129 that enables an instructor 137 to shut down one or more system components.

Additionally or alternatively, safety module 129 provides an audio signal through a speaker 126 to indicate, for example, that a ceasefire is in effect. The use of physical signal 126 allows shooters 102 who are wearing or not wearing earphones 136, for example, to be alerted to events.

In alternative embodiments, safety module 129 provides physical signals 126, for example, inter alia, a flag, tape or a sign. In further embodiments, safety module 129 produces automated audio commands that instruct shooters 102 to, for example, start shooting, stop shooting, change position from standing to crouching.

Additionally or alternatively, safety module 129 may include a wireless command system that is transmitted wirelessly to earphones 136 so that the instructor can wirelessly instruct shooters 102 to begin, pause or stop operations.

The inventor has discovered that shooting range management system 100 using a dedicated processing module (not shown) can optionally enable real time monitoring, processing, analyzing and/or viewing of a multi-user training session.

Consistent with some embodiment of the invention, processing module may further be arranged to calculate at least one of: (i) a location of a hit on the target; (ii) a timing of each shot on a specified target; (iii) an association of a series of shots and a specific shooter; (iv) an association of a series of shots and a shooting history of a specific shooter; and (v) recommendations improvement of shooting skills based on the processing and further in view of a series of shots of a specific shooter.

The inventors have additionally discovered that shooting range management system 100 optionally enables post session training or shooting analysis and output, for example, to facilitate group or individual training analysis, feedback and monitoring.

The inventors have further discovered that shooting range management system 100 optionally enables, inter alia, real time or non-real time analysis and display of target hitting percentages, accuracy in area of target hit, shooting speed, and time spent on preparation of weapons in preparation for firing and/or operating the weapon in firing (such as, for example, replacing a cartridge and/or jam operation).

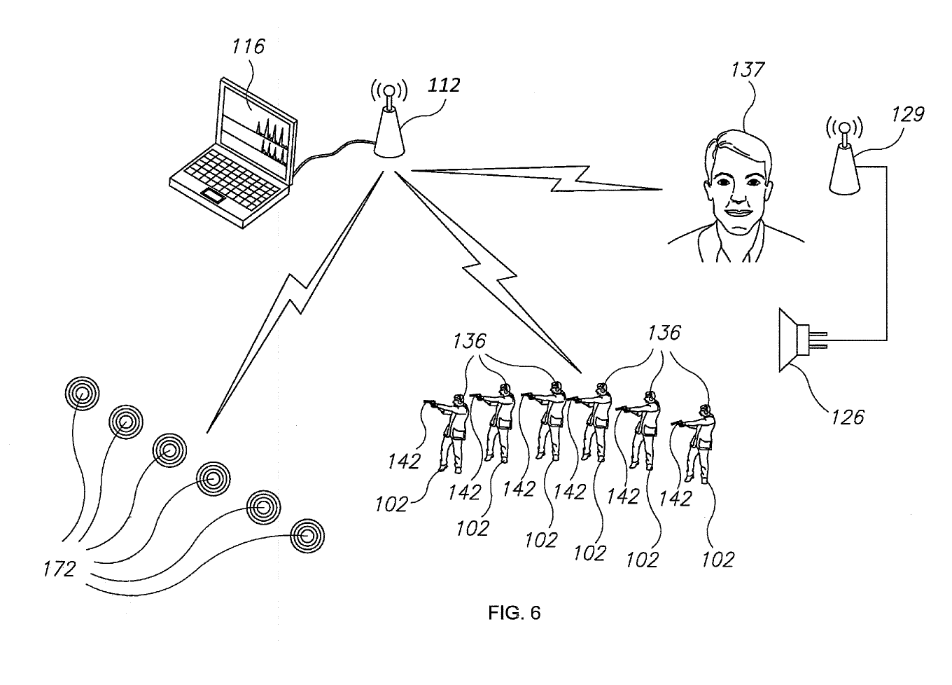

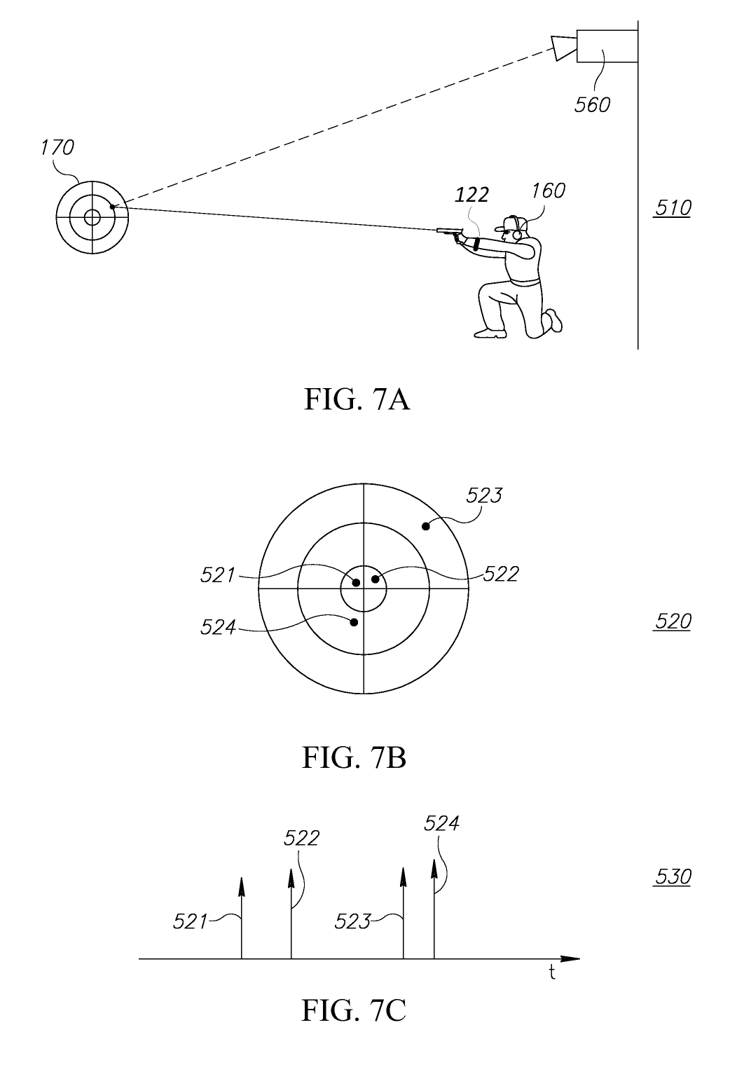

FIG. 7A shows yet another aspect of a shooting range management system, according to some embodiments of the invention. Shooting management system 510 includes shot recorder/monitoring device 122 associated with a specific shooter 160, which may include, for example, a user shot monitoring device 600 as described in detail herein. In addition to a target 170, there is provided an imaging device (such as a camera) 560 that faces the target. In operation, imaging device captures images (or a video sequence) of target 170. It is understood the imaging device 560 can capture a plurality of target accommodating a plurality of shooters (not shown here). The captured images are used by embodiments of the present invention by processing them and presenting the images in conjunction with data associated with the respective shooter, the timeline and each shooter specific training scheme.

Consistent with one embodiment, FIG. 7B shows an exemplary presented image of a target 520 showing the hits of a specified shooter indicated by 521-524. Advantageously—the shot monitoring device and the management system may help determine which hit is associated with which shot along a time line as indicated in FIG. 7C showing a timeline 530 with hits of a specified shooter indicated by 521-524.

Moreover, the target 520 is being recorded by an image device 560. The image is being processed to provide an accurate location of a hit on the target 520. A tracking and location system may identify a location of a shooter in a shooting arena when the shooter is in movement, the shooter is identified by the tracking and location system.

In the above description, an embodiment is an example or implementation of the inventions. The various appearances of “one embodiment”, “an embodiment”, or “some embodiments”, do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment”, or “other embodiments”, means that a particular feature, structure, or characteristic described in connection with the embodiments is included in at least some embodiments, but not necessarily all embodiments, of the inventions.

It is to be understood that the phraseology and terminology employed herein are not to be construed as limiting, and are for descriptive purposes only.

The principles and uses of the teachings of the present invention may be better understood with reference to the accompanying description, Figures, and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting”, and grammatical variants thereof do not preclude the addition of one or more components, features, steps, or integers; or groups thereof, and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques, and procedures by practitioners of the art to which the invention belongs.

The descriptions, examples, methods, and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention may be implemented in the testing or practice with methods and materials equivalent or similar to those described herein.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

1. A device for monitoring shots fired by a specific user, the device comprising:
an identification module to store an exclusive identification and to enable exclusive identification of a specific shooter by ascribing the exclusive identification to the shooter;
a memory module;
a wireless communications module; and
a motion sensor to sense data about the amplitude and direction of movements of a user's hand and to provide the data to a processor external to the device via the wireless communications module.

2. The device of claim 1, further comprising attachment straps to facilitate attachment of the device to a wrist of a user.

3. The device of claim 1, further comprising a processing module to at least partially process data before providing the processed data to the external processor.

4. The device of claim 1, further comprising at least one physiological sensor to sense data about physiological measures that imply on physiological or emotional conditions of the user and to provide the data to the external processor via the wireless communications module.

5. The device of claim 1, further comprising an audio sensor to detect audio data comprising sounds made by the user, by the weapon and/or from the user's environment and to provide the data to the external processor via the wireless communications module.

6. The device of claim 1, wherein the memory module stores at least one of a list comprising: shooting history, performance, rank, and/or any other suitable data about the specific user.

7. The device of claim 1, wherein the identification module comprises RFID reader for synchronization with a corresponding RFID tag on a corresponding weapon or target.

8. A system for monitoring shots fired by a specific user, the system comprising:
a processor;
a monitoring device for monitoring shots fired by a specific user, the device comprising:
an identification module to store an exclusive identification and to enable exclusive identification of a specific shooter by ascribing the exclusive identification to the shooter;
a memory module;
a wireless communications module; and
a motion sensor to sense data about the amplitude and direction of movements of a user's hand and to provide the data to the processor, the processor external to the device, via the wireless communications module,
wherein the processor is configured to receive data from the device and to process the data to identify typical movement patterns before, during and after a firing.

9. The system of claim 8, wherein the processor is configured to isolate at least horizontal movement of the hand and depth movement of the hand.

10. The system of claim 8, wherein the processor is configured to identify recoil movement and deduce that a shot has been fired at the same time that the recoil movement occurred.

11. The system of claim 8, wherein the device further comprises attachment straps to facilitate attachment of the device to a wrist of a user.

12. The system of claim 8, wherein the device further comprises a processing module to at least partially process data before providing the processed data to the external processor.

13. The system of claim 8, wherein the device further comprises at least one physiological sensor to sense data about physiological measures that imply on physiological or emotional conditions of the user and to provide the data to the external processor via the wireless communications module.

14. The system of claim 8, wherein the device further comprises an audio sensor to detect audio data comprising sounds made by the user, by the weapon and/or from the user's environment and to provide the data to the external processor via the wireless communications module.

15. The system of claim 8, wherein the memory module stores at least one of a list comprising: shooting history, performance, rank, and/or any other suitable data about the specific user.

16. The system of claim 8, wherein the identification module comprises RFID reader for synchronization with a corresponding RFID tag on a corresponding weapon or target.

17. The system of claim 8, wherein the processor is calibrated to identify different types of movement according to various parameters.

18. The system of claim 8, further comprising an impact recorder to detect impacts of shots on a target, wherein the processor is further configured to attribute data received from the impact recorder to the correct user exclusively.

19. The system of claim 8, comprising a plurality of monitoring devices, each identified with a respective shooter by the identification module of each device, the system further comprising:
a timer; and
at least one impact recorder monitoring at least one target,
wherein the processor is configured to receive data from the plurality of monitoring devices and impact recorders in parallel, to process the data to identify typical movement patterns before, during and after firing and to time identified shots, made by the respective identified shooters, and impacts thereof.
